(19) United States
(12) Patent Application Publication
(10) Pub. No.: US 2025/0379017 A1
(43) Pub. Date: Dec. 11, 2025

(54) FUSED SINGLE POINT HIGH VOLTAGE CONTACTOR WITH FAST DISCONNECT

(71) Applicant: SENSATA TECHNOLOGIES, INC., ATTLEBORO, MA (US)

(72) Inventors: PETER DONGHAE SONG, SANTA BARBARA, CA (US); CORY ZEPHIR BOUSQUET, UXBRIDGE, MA (US)

(21) Appl. No.: 18/876,660

(22) PCT Filed: Sep. 12, 2023
(86) PCT No.: PCT/US2023/032484

§ 371 Date: Dec. 18, 2024

Related U.S. Application Data
(60) Provisional application No. 63/417,373, filed on Oct. 19, 2022.

(51) Int. Cl. H01H 50/54; H01H 50/44; H01H 50/64

(52) U.S. Cl. CPC H01H 50/54; H01H 50/44; H01H 50/641

(57) ABSTRACT

Apparatuses and methods for high voltage contactors are disclosed. In a particular embodiment, a contactor includes a high voltage input terminal; a high voltage output terminal; and a switch having a first closed position, a second closed position, and an open position, wherein the switch establishes a first high voltage current path between the high voltage input terminal and the high voltage output terminal in the first closed position and a second high voltage current path between the high voltage input terminal and the high voltage output terminal in the second closed position.

### BACKGROUND

Electromechanical switching devices, such as contactors and relays, are designed to carry a certain amount of electrical current for certain periods of time. Such devices are particularly important in electric vehicles. Typically, electric vehicles use discrete contactors and fuses for breaking and disconnect during a fault. While some contactors offer size/cost reductions for high performance electric vehicles compared to discrete components, for lower cost electric vehicles such products may be too expensive.

### SUMMARY

Apparatuses and methods for a fused single point high voltage contactor with fast disconnect are disclosed. In various embodiments, the contactor is a single pole double throw (SPDT) contactor having a low resistance path optimized for high current carry and thermal efficiency on the primary throw and a melting fuse on the secondary throw for one-time fault clearing. The outputs of the double throw are shorted together. This provides a low-cost contactor and fast disconnect function. The secondary throw will not be used in normal operation but will be engaged in the event of a fault. In some variations, a pyrotechnic charge is used to actuate the secondary throw. In some variations, a cam with multiple lobes is used to actuate the secondary throw. In some variations, a latching contactor includes a hard stop is retracted to allow a return spring to pull the contactor into the secondary pole. The need for a hermetic arc chamber is eliminated from the contactor. Thus, the contactor does not depend on arc chutes and only needs a single break, which is preferential for contact resistance. In some variations, a contactor uses a melting fuse to clear the fault. Due to the SPDT switch, the issue of fuse aging is eliminated.

In a particular embodiment, a contactor is disclosed that includes a high voltage input terminal and a high voltage output terminal. In this embodiment, the contractor also includes a switch having a first closed position, a second closed position, and an open position. The switch establishes a first high voltage current path between the high voltage input terminal and the high voltage output terminal in the first closed position and a second high voltage current path between the high voltage input terminal and the high voltage output terminal in the second closed position.

In another particular embodiment, a method of operating a contractor is disclosed that includes receiving, by a coil of the contactor, a low voltage current. Application of the low voltage current induces a switch in the contactor to move from an open position to a first closed position. The switch establishes a first high voltage current path between a high voltage input terminal and a high voltage output terminal in the first closed position. The method also includes detecting, by a pyrotechnic element of the contactor, a current that exceeds a current threshold and inducing, by the pyrotechnic element, the switch to move to a second closed position. In this embodiment, the switch establishes a second high voltage current path between the high voltage input terminal and the high voltage output terminal in the second closed position.

In another embodiment, a method of operating a contactor is disclosed that includes receiving, by a motor in the contactor, a signal to rotate a cam. Rotation of the cam moves a switch of the contactor between a first closed position, a second closed position, and an open position. The switch establishes a first high voltage current path between the high voltage input terminal and the high voltage output terminal in the first closed position and a second high voltage current path between the high voltage input terminal and the high voltage output terminal in the second closed position.

In another embodiment, a method of operating a contractor is disclosed that includes receiving a signal at an input of the conductor and responsive to receiving the signal. inducing a switch in a conductor to move between a first closed position, a second closed position, and an open position. In this embodiment, the switch establishes a first high voltage current path between a high voltage input terminal and a high voltage output terminal in the first closed position and a second high voltage current path between the high voltage input terminal and the high voltage output terminal in the second closed position.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A is a schematic of an example fused single point contactor with fast disconnect according to at least one embodiment of the present disclosure.

FIG. 1B is another schematic of the contactor of FIG. 1A.

FIG. 1C is another schematic of the contactor of FIG. 1A.

FIG. 2A is a diagram of a sectional view of another example fused single point contactor with fast disconnect according to at least one embodiment of the present disclosure.

FIG. 2B is another view of the contactor of FIG. 2A.

FIG. 2C is another view of the contactor of FIG. 2A.

FIG. 3A is a schematic of another example fused single point contactor with fast disconnect according to at least one embodiment of the present disclosure.

FIG. 3B is another schematic of the contactor of FIG. 3A.

FIG. 3C is another schematic of the contactor of FIG. 3A.

FIG. 4A is a diagram of a sectional view of another example fused single point contactor with fast disconnect according to at least one embodiment of the present disclosure.

FIG. 4B is another view of the contactor of FIG. 2A.

FIG. 4C is another view of the contactor of FIG. 2A.

FIG. 5 is a flowchart of an example method of operating a fused single point contactor with fast disconnect according to at least one embodiment of the present disclosure.

FIG. 6 is a flowchart of an example method of operating a fused single point contactor with fast disconnect according to at least one embodiment of the present disclosure.

FIG. 7 is a flowchart of an example method of operating a fused single point contactor with fast disconnect according to at least one embodiment of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality

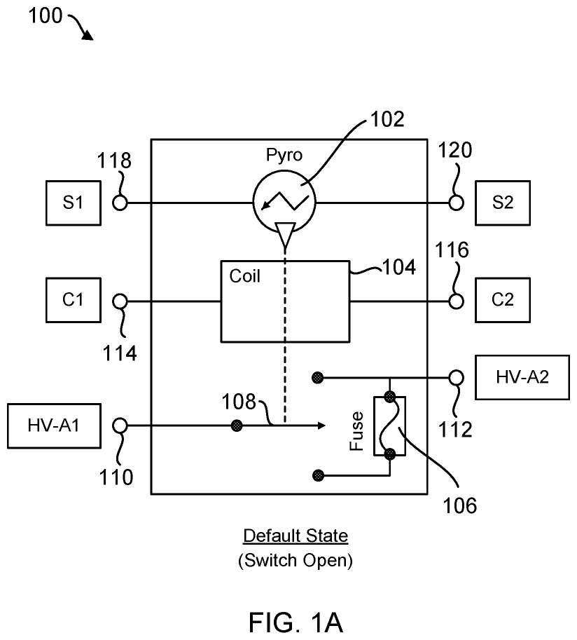

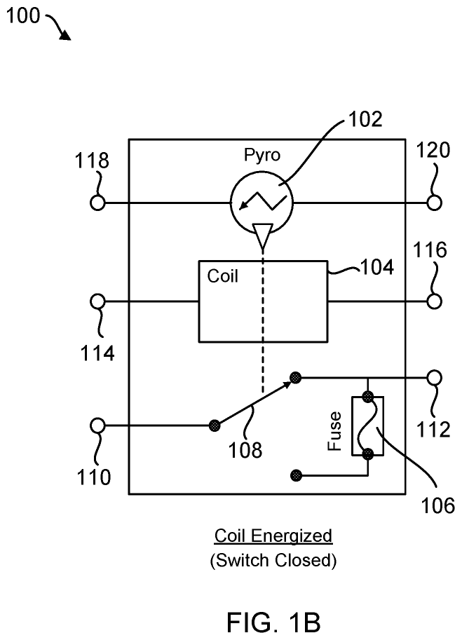

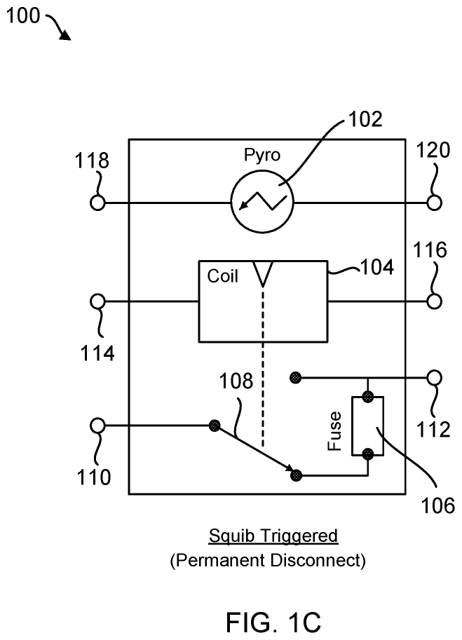

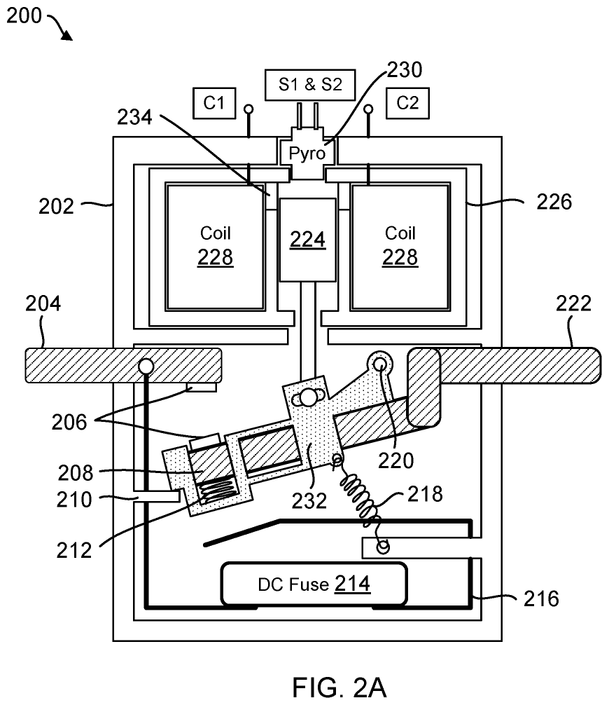

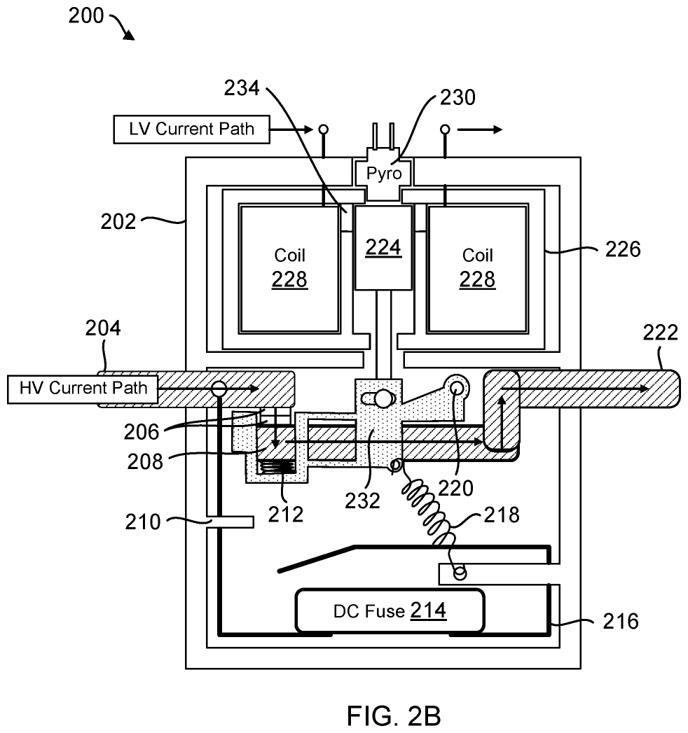

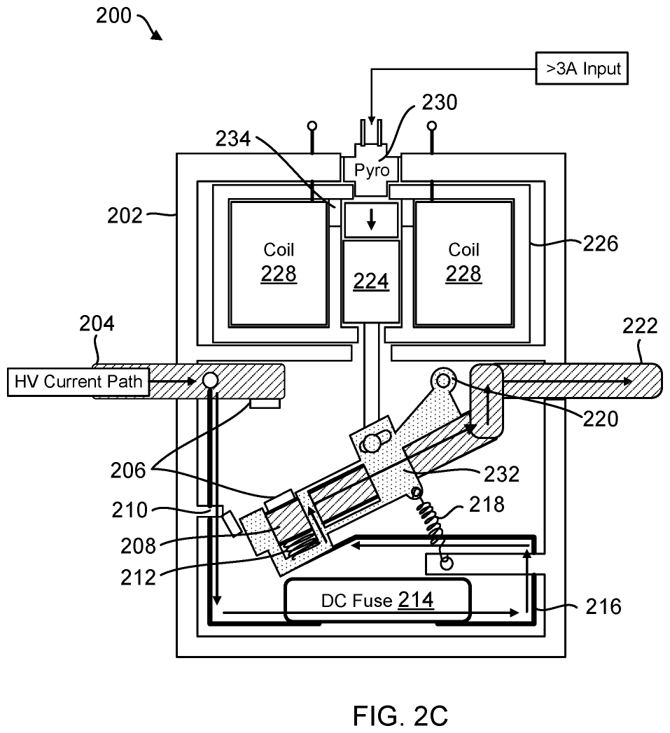

For further explanation, FIGS. 1A-1C set forth schematics for an example single break, fast disconnect contactor 100 in accordance with at least one embodiment of the present disclosure. The example contactor 100 includes a single pole double throw (SPDT) switch 108 that switches the current path between two high voltage current terminals 110, 112. In FIG. 2A the switch 108 is shown in the open position, which in this example is the default position. The contactor also includes a coil 104 that is excited by a low voltage current through terminals 114, 116. When excited, the coil 104 actuates (e.g., via a plunger or actuator) the switch 108 into a first closed position shown in FIG. 1B, thus establishing a first current path between the high voltage current terminals 110, 112. The example contactor 100 also includes a pyrotechnic charge 102 coupled to terminals 118, 120 (S1, S2). A specified high current load on the pyrotechnic charge 102 via the terminals 118, 120 will detonate the pyrotechnic charge 102, the force of which actuates (e.g., via a plunger or actuator) the switch into a second closed position shown in FIG. 1C, thus disconnecting the first current path and establishing a second current path between the high voltage current terminals 110, 112. The second current path includes a fuse 106 (e.g., a melting fuse). In some examples, the fuse nominal current rating is substantially underrated for fast disconnect during the change of state. When the fuse 106 is blown, the contactor 100 is in a state of permanent disconnect.

For further explanation, FIGS. 2A-2C set forth diagrams illustrating a sectional view an example contactor 200 in accordance with at least one embodiment of the present disclosure. In some examples, the contactor 200 design is in accordance with the schematics of the contactor 100 in FIGS. 1A-1C. The contactor 200 includes a single pole, double throw switch in which a common high voltage input is switched between two circuits within a housing 202 of the contactor 200. In some examples, the housing 202 is a plastic housing that is not hermetically sealed, thus lessening manufacturing costs. The outputs of the circuits are shorted together at a single high voltage output terminal. In some examples, the high voltage input terminal is an input bus bar 204 and the high voltage output terminal is an output bus bar 222. In some examples, at least one bus bar is a solid bus bar. In some examples, at least one bus bar is a laminated bus bar. The SPDT switch implemented by the contactor 200 includes a first closed or ‘on’ position, an open or ‘off’ position, and a second closed or ‘on’ position. The high voltage bus bars 204, 222 are electrically couplable by a pivotable contactor linkage 208 (i.e., the pole) that switches between the two circuits. In some examples, the contactor linkage 208 is pivotably connected to one of the bus bars 222. FIG. 2A depicts the SPDT switch in the open position in which the contactor linkage 208 is electrically isolated from the input bus bar 204. This may be the default position. The contactor linkage 208 is supported by a contactor support assembly 232 that facilitates pivoting of the contactor linkage 208 around a pivot point 220. The contactor support assembly 232 may also include a return spring 218 that is coupled to a portion of the housing 202. In some examples, the return spring 218 biases contactor support assembly 232, and thus the contactor linkage 208, away from the input bus bar 204 and against a stopper as shown in FIG. 2A. The input bus bar 204 and the contactor linkage 208 may include contactor pads 206 that facilitate the contact between the bus bar 204 and the contactor linkage 208 in the first closed position as shown in FIG. 2B. The contactor support assembly 232 may include a contactor spring 212 that biases the contactor linkage 208 toward the input bus bar 204 in the first closed position as shown in FIG. 2B. In some examples, the housing 202 includes hard stop 210 that stops the contactor support assembly 232 from moving to the second closed position until the contactor 200 is triggered by a high current. For example, the hard stop 210 may be a shearing hard stop that breaks or collapses in response to sufficient force as shown in FIG. 2C.

The contactor support assembly 232 is coupled to a plunger 224 disposed between two coils 228. When the coils 228 are energized by application of current to C1, C2, the plunger 224 moves the contactor support assembly 232, and thus the contactor linkage 208, between the open and the first closed position. Each coil 228 is surrounded by a magnetic core 226 that includes a non-magnetic sleeve 234. FIG. 2B illustrates the contactor 200 where the switch is in the first closed position. Energization of the coils 228 creates an electromagnetic field that pushes the plunger 224 upward toward the non-magnetic sleeve 234. which pulls the contactor support assembly 232 upward. which moves the contactor linkage 208 toward the bus bar 204. The contact pads 206 make contact, and a primary high voltage current path (indicated by arrows) is created from the input bus bar 204, through the contactor linkage 208, to the output bus bar 222. A low voltage current path (also indicated by arrows) is applied from one coil 228 to the other coil 228 to energize the coils 228.

The example contactor 200 also includes a pyrotechnic element 230. When a high current load greater than a specified current threshold (e.g., greater than 3 amperes) is applied to the pyrotechnic element 230, the pyrotechnic element 230 is triggered and detonates. The force of the detonation drives the plunger 224 downward, which drives the contactor support assembly 232 downward with a force that causes the contactor linkage 208 to break contact with the bus bar 204 (and breaking the first current path), and further causes the contactor support assembly 232 to impact the hard stop 210, thus shearing, breaking or collapsing the hard stop 210 as shown in FIG. 2C. With nothing to stop the contactor support assembly 232 from being further pulled by the return spring 218, the return spring 218 pulls the contactor support assembly 232 and the contactor linkage 208 into the second closed position in which the contactor linkage 208 contacts a fuse lead frame 216 as shown in FIG. 2C. In the second closed position, a secondary high voltage current path flows from the bus bar 204, through the fuse lead frame 216 and a fuse 214, through the contactor linkage 208, to the bus bar 222 as shown in FIG. 2C. The fuse 214 may be a melting fuse for one time fault clearing of the secondary high voltage current path. The secondary high voltage current path, including a fuse 214, is optimized for high current fault, whereas the primary high voltage current path is optimized for low resistance and thermal efficiency. In an alternative embodiment, the hard stop 210 is a retractable hard stop. In some examples of the alternative embodiment, the pyrotechnic element 230 may be omitted.

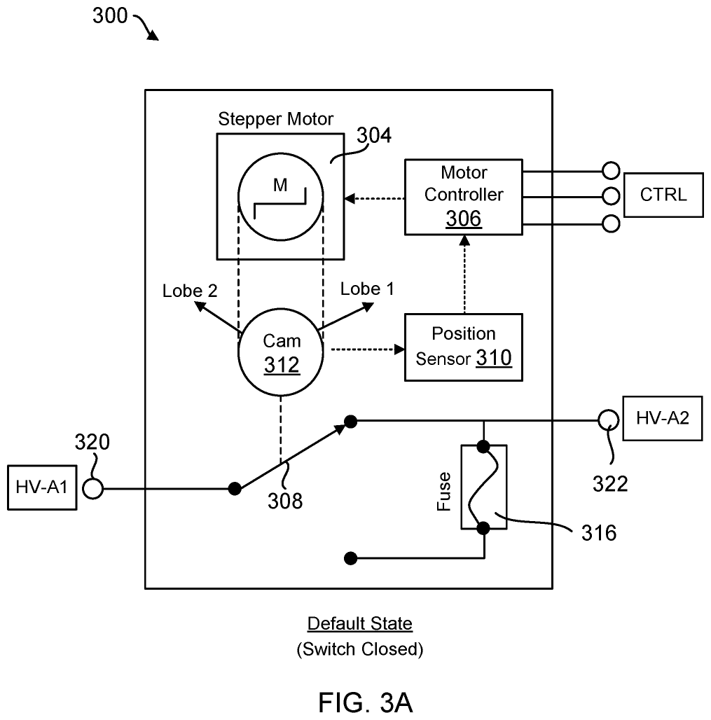

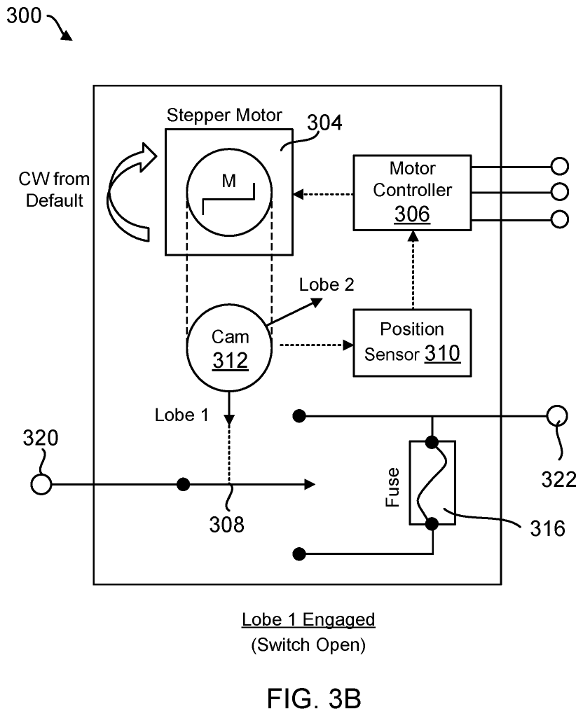

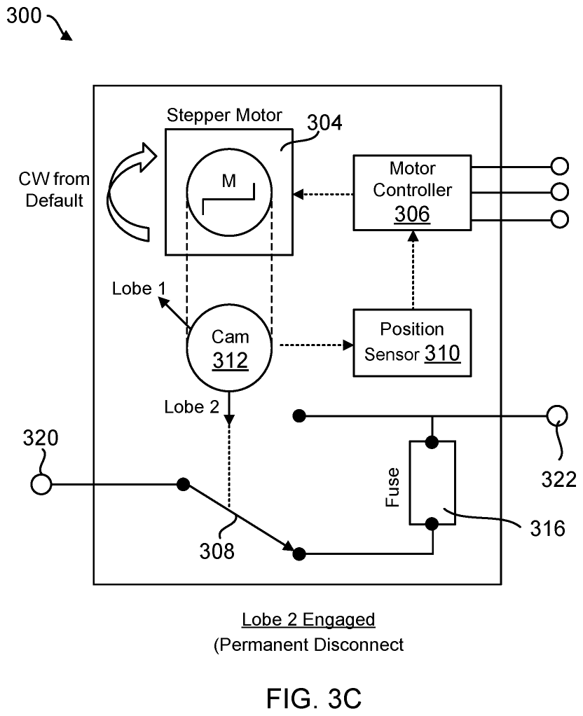

For further explanation, FIGS. 3A-3C set forth schematics for an example single break, fast disconnect contactor 300 in accordance with at least one embodiment of the present disclosure. The example contactor 300 includes a single pole double throw (SPDT) switch 308 that switches the current path between two high voltage current terminals 320, 322. In FIG. 3A the switch 308 is shown in a first closed position, which in this example is the default position. In the first closed position, a first current path is established between high voltage current terminals 320, 322. The contactor also includes a motor 304 that is controlled by a motor controller 306. The motor 304 rotates a cam 312 that includes multiple lobes. A position sensor 310 determines the position of the cam 312 and feeds the position back to the motor controller 306. To open the switch, the motor 304 rotates the cam 312 in a first direction until a first lobe exerts a mechanical force on the switch 308 that moves the switch 308 into the open position, as shown in FIG. 3B. To move the switch 308 to the second closed position shown in FIG. 3C, the motor 304 rotates the cam 312 (in an opposite second direction) until a second lobe exerts a mechanical force on the switch 308 that moves the switch 308 into the second closed position, thus disconnecting the first current path and establishing a second current path between the high voltage current terminals 320, 322. The second lobe extends farther from the center of the cam than the first lobe. The second current path includes a fuse 316 (e.g., a melting fuse). In some examples, the fuse nominal current rating is substantially underrated for fast disconnect during the change of state.

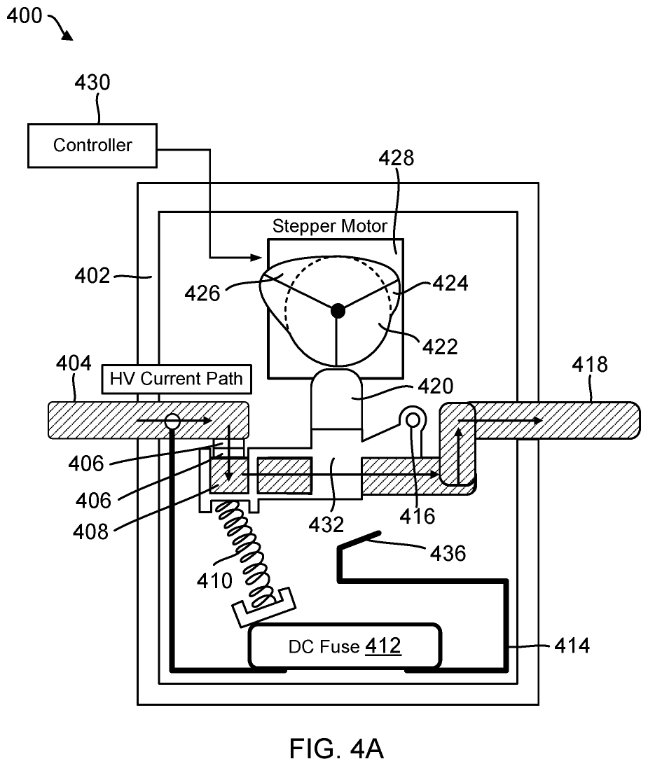

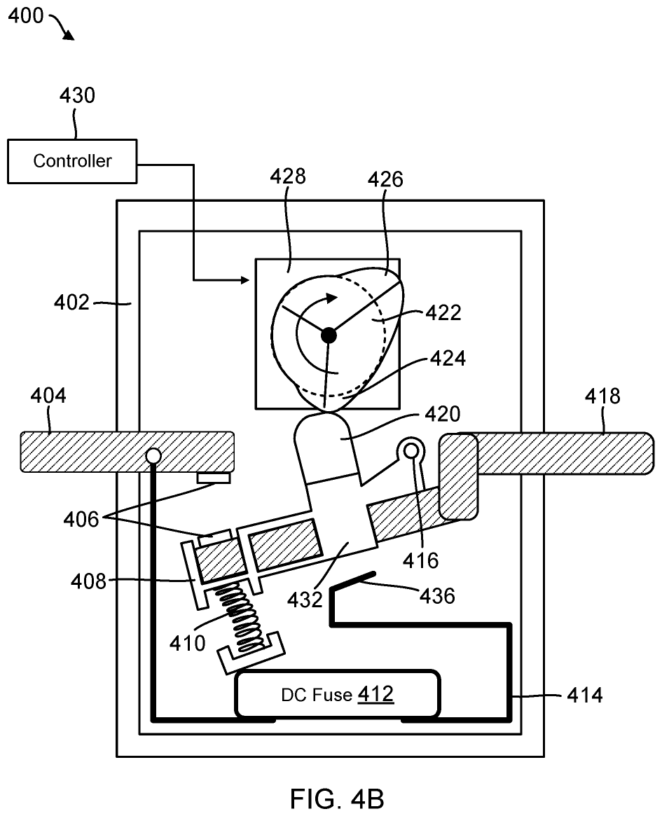

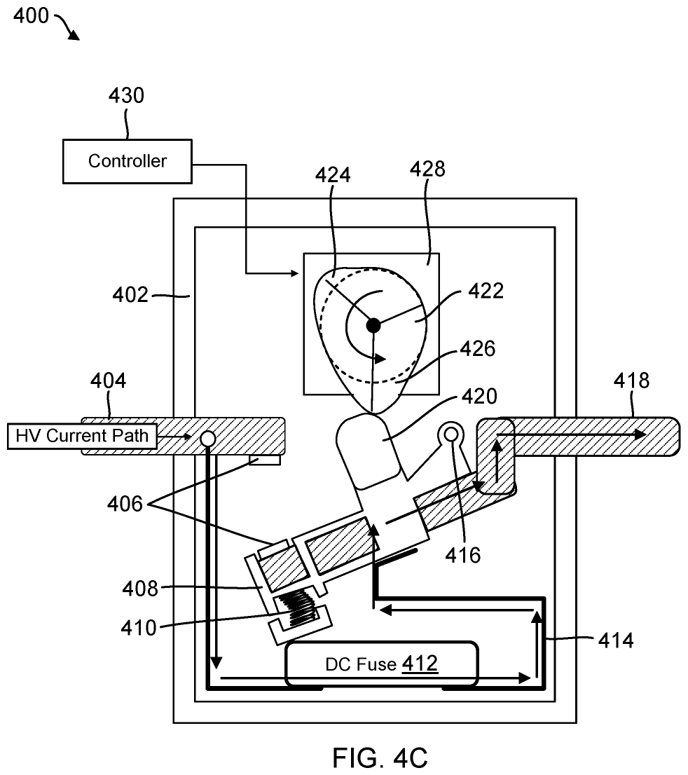

For further explanation, FIG. 4A-4C set forth diagrams illustrating a sectional view an example contactor 400 in accordance with at least one embodiment of the present disclosure. In some examples, the contactor 400 design is in accordance with the schematics of the contactor 300 in FIGS. 3A-3C. The contactor 400 includes a single pole, double throw switch in which a common high voltage input is switched between two circuits within a housing 402 of the contactor 400. In some examples, the housing 402 is a plastic housing that is not hermetically sealed, thus lessening manufacturing costs. The outputs of the circuits are shorted together at a single high voltage output terminal. In some examples, the high voltage input terminal is an input bus bar 404 and the high voltage output terminal is an output bus bar 418. In some examples, at least one bus bar is a solid bus bar. In some examples, at least one bus bar is a laminated bus bar. The SPDT switch implemented by the contactor 400 includes a first closed or ‘on’ position, an open or ‘off’ position, and a second closed or ‘on’ position. The high voltage bus bars 404, 418 are electrically couplable by a pivotable contactor linkage 408 (i.e., the pole) that switches between the two circuits. In some examples, the contactor linkage 408 is pivotably connected to one of the bus bars 418. FIG. 4A depicts the SPDT switch in the first closed position (in this example, the default position) in which the contactor linkage 408 physically contacts the input bus bar 404 and is pivotably coupled to the output bus bar 418. The contactor linkage is supported by a contactor support assembly 432 that facilitates pivoting of the contactor linkage 408 around a pivot point 416. The contactor support assembly 432 may also include a return spring 410 that is coupled to a fuse 412 or some portion of the housing 402. In some examples, the return spring 410 biases contactor support assembly 432, and thus the contactor linkage 408, away from the input bus bar 404. The input bus bar 404 and the contactor linkage 408 may include contactor pads 406 that facilitate the contact between the bus bar 404 and the contactor linkage 408 in the first closed position.

The contactor support assembly 432 is coupled to a lifter 420 that interfaces with a cam 422, which is controlled by a controller 430. The cam 422 is driven by a motor 428, such as a stepper motor 428. The cam 422 includes a primary lobe 424 and a secondary lobe 426. As shown in FIG. 4A in the first closed position, the lifter 420 is not engaged by the lobes 424, 426 of the cam 422 and the contact pads 406 are in contact. A primary high voltage current path (indicated by arrows) is created from the input bus bar 404, through the contactor linkage 408, to the output bus bar 418. When the controller 430 receives a signal to open the contactor 400, the controller 430 causes the motor 428 to rotate the cam 422 in a first direction such that the primary lobe 424 engages the lifter 420, thus pushing the lifter 420 downward, which drives the contactor support assembly 432 downward and causing the contactor linkage 408 to break contact with the input bus bar 404, as shown in FIG. 4B. In FIG. 4B. the contactor 400 is in the open position. When the controller 430 receives a signal indicating high current or a current fault, the controller 430 places the contactor in the second closed position by controlling the motor 428 to rotate the cam 422 in a second opposite direction such that the secondary lobe 426 engages the lifter 420, pushing the lifter 420 downward, which drives the contactor support assembly 432 downward and causing the contactor linkage 408 to contact with the contact portion 436 of the fuse lead frame 414, as shown in FIG. 4C. The secondary lobe 426 extends farther from the center of the cam 422 than the primary lobe 424, and thus the secondary lobe pushes the contactor support assembly farther downward than the open position. In the second closed position shown in FIG. 4C, a secondary high voltage current path flows from the input bus bar 404. through the fuse lead frame 414 and fuse 412, through the contactor linkage 408, to the output bus bar 418. The fuse 412 may be a melting fuse for one time fault clearing of the secondary high voltage current path. The secondary high voltage current path, including the fuse 412, is optimized for high current fault, whereas the primary high voltage current path is optimized for low resistance and thermal efficiency.

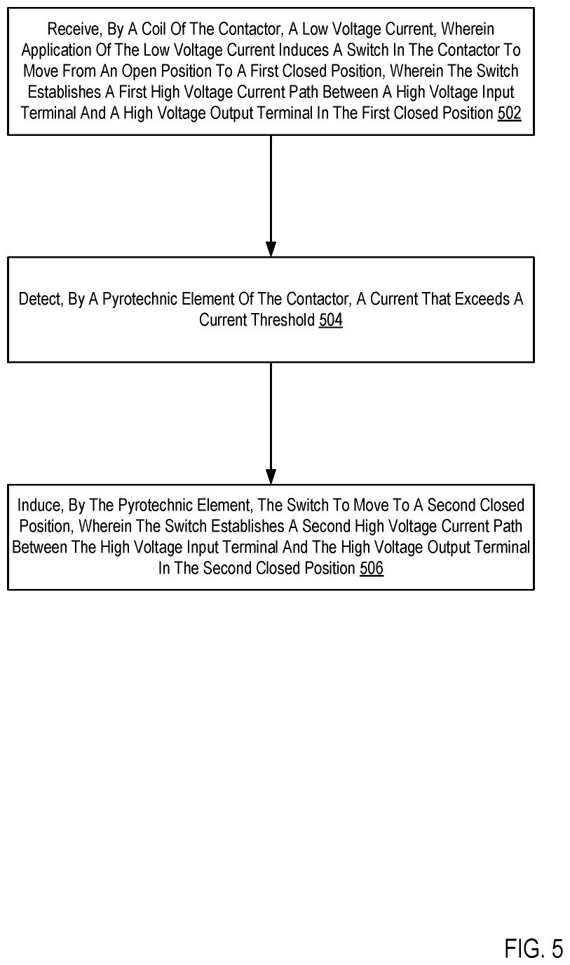

For further explanation, FIG. 5 sets forth a flow chart illustrating an example method of operating a single point contactor with fast disconnect in accordance with at least one embodiment of the present disclosure. The method of FIG. 5 includes receiving 502, by a coil of the contactor, a low voltage current, wherein application of the low voltage current induces a switch in the contactor to move from an open position to a first closed position, wherein the switch establishes a first high voltage current path between a high voltage input terminal and a high voltage output terminal in the first closed position. In some examples, receiving 502, by the coil of the contactor, a low voltage current is carried out as described above with reference to FIGS. 1A-1C and FIGS. 2A-2C. The method of FIG. 5 also includes detecting 504, by a pyrotechnic element of the contactor, a current that exceeds a current threshold. In some examples, detecting 504, by a pyrotechnic element of the contactor, a current that exceeds a current threshold is carried out as described above with reference to FIGS. 1A-1C and FIGS. 2A-2C. The method of FIG. 5 also includes inducing 506, by the pyrotechnic element, the switch to move to a second closed position, wherein the switch establishes a second high voltage current path between the high voltage input terminal and the high voltage output terminal in the second closed position. In some examples, inducing 506, by the pyrotechnic element, the switch to move to a second closed position is carried out as described above with reference to FIGS. 1A-1C and FIGS. 2A-2C.

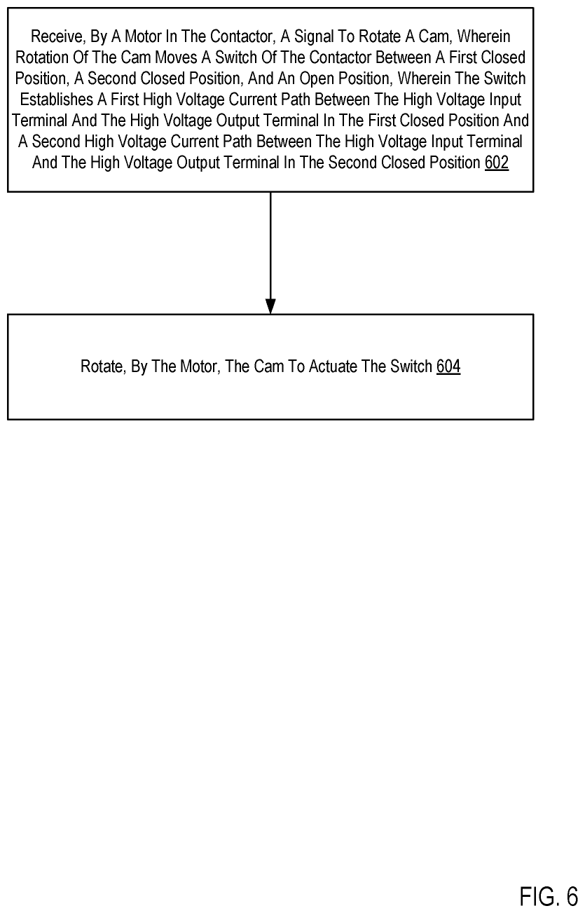

For further explanation, FIG. 6 sets forth a flow chart illustrating an example method of operating a single point contactor with fast disconnect in accordance with at least one embodiment of the present disclosure. The method of FIG. 6 includes receiving 602, by a motor in the contactor, a signal to rotate a cam, wherein rotation of the cam moves a switch of the contactor between a first closed position, a second closed position, and an open position, wherein the switch establishes a first high voltage current path between the high voltage input terminal and the high voltage output terminal in the first closed position and a second high voltage current path between the high voltage input terminal and the high voltage output terminal in the second closed position. In some examples, receiving 602, by a motor in the contactor, a signal to rotate a cam is carried out as described above with reference to FIGS. 3A-3C and FIGS. 4A-4C. The method of FIG. 6 also includes rotating 604, by the motor, the cam to actuate the switch. In some examples, rotating 604, by the motor, the cam to actuate the switch is carried out as described above with reference to FIGS. 3A-3C and FIGS. 4A-4C.

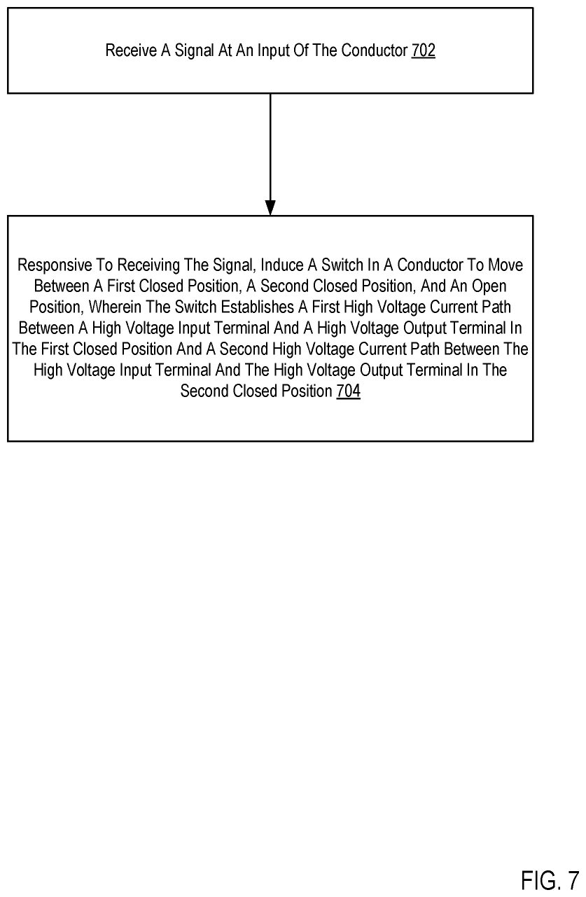

For further explanation, FIG. 7 sets forth a flow chart illustrating an example method of operating a single point contactor with fast disconnect in accordance with at least one embodiment of the present disclosure. The method of FIG. 6 includes receiving 702 a signal at an input of the conductor. In some examples, receiving 702 a signal at an input of the conductor may be carried out with reference to FIGS. 1A-1C, FIGS. 2A-C, FIGS. 3A-C, and FIGS. 4A-C. For example, in FIGS. 1A-C, the contactor may receive the signal at input terminal 118. In FIGS. 2A-C, the signal may be received at the current input C1. In FIGS. 3A-C, the signal may be received by the motor controller 306. In the example of FIGS. 4A-C, the signal may be a signal received by the controller 430 or from the controller 430. The method of FIG. 6 also includes responsive to receiving the signal, inducing a switch in a conductor to move between a first closed position, a second closed position, and an open position, wherein the switch establishes a first high voltage current path between a high voltage input terminal and a high voltage output terminal in the first closed position and a second high voltage current path between the high voltage input terminal and the high voltage output terminal in the second closed position. In some examples, inducing a switch in a conductor to move between a first closed position, a second closed position, and an open position is carried out as described above with reference to FIGS. 1A-1C, FIGS. 2A-C, FIGS. 3A-C, and FIGS. 4A-C.

The flowchart and block diagrams in the Figures illustrate the architecture, functionality, and operation of possible implementations of systems, apparatuses, and methods, according to various embodiments of the present invention.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A contactor comprising;
a high voltage input terminal;
a high voltage output terminal; and
a switch having a first closed position, a second closed position, and an open position, wherein the switch establishes a first high voltage current path between the high voltage input terminal and the high voltage output terminal in the first closed position and a second high voltage current path between the high voltage input terminal and the high voltage output terminal in the second closed position.

2. The contactor of claim 1, wherein the switch includes a pivotable contactor linkage.

3. The contactor of claim 1 further comprising:
a coil couplable to a low voltage current supply; and
a plunger, wherein excitation of the coil by the low voltage current supply induces movement of the plunger to actuate the switch into the first closed position.

4. The contactor of claim 3 further comprising a pyrotechnic element that is triggerable by a threshold current level, wherein triggering of the pyrotechnic element induces movement of the plunger to actuate the switch into the second closed position.

5. The contactor of claim 1 further comprising:
a cam having a first lobe and a second lobe;
a lifter that engages the cam;
a motor that drives rotation of the cam; and
a controller of the motor.

6. The contactor of claim 5, wherein a default position of the switch is the first closed position; wherein the lifter actuates the switch into the open position through engagement of the first lobe of the cam; wherein the lifter actuates the switch into the second closed position through engagement of the second lobe of the cam.

7. The contactor of claim 6, wherein the controller controls the motor to: rotate the cam into a first cam position in which the first lobe engages the lifter; and rotate the cam into a second cam position in which the second lobe engages the lifter.

8. The contactor of claim 7, wherein the controller rotates the cam into the second cam position in response to detecting a current above a threshold level.

9. The contactor of claim 1, wherein there is no high voltage current path between the high voltage input terminal and the high voltage output terminal in the open position.

10. The contactor of claim 1, wherein the second high voltage current path between the high voltage input terminal and the high voltage output terminal includes a fuse.

11. The contactor of claim 10, wherein the fuse is a melting fuse.

12. The contactor of claim 10, wherein the first high voltage current path between the high voltage input terminal and the high voltage output terminal does not include a fuse.

13. A method of operating a contactor, the method comprising:
receiving a signal at an input of the conductor; and
responsive to receiving the signal, inducing a switch in a conductor to move between a first closed position, a second closed position, and an open position, wherein the switch establishes a first high voltage current path between a high voltage input terminal and a high voltage output terminal in the first closed position and a second high voltage current path between the high voltage input terminal and the high voltage output terminal in the second closed position.

14. The method of claim 13 wherein the contractor includes:
a coil couplable to the input of the conductor; and
a plunger, wherein excitation of the coil by the signal induces movement of the plunger to actuate the switch into the first closed position.

15. The method of claim 14 wherein the contractor further includes a pyrotechnic element that is triggerable by a threshold current level, wherein triggering of the pyrotechnic element induces movement of the plunger to actuate the switch into the second closed position.

16. The method of claim 13 wherein the contractor further includes:
a cam having a first lobe and a second lobe;
a lifter that engages the cam;
a motor that drives rotation of the cam; and
a controller of the motor.

17. The method of claim 16, wherein a default position of the switch is the first closed position; wherein the lifter actuates the switch into the open position through engagement of the first lobe of the cam; wherein the lifter actuates the switch into the second closed position through engagement of the second lobe of the cam.

18. The method of claim 17, wherein the controller controls the motor to: rotate the cam into a first cam position in which the first lobe engages the lifter; and rotate the cam into a second cam position in which the second lobe engages the lifter.

19. The method of claim 18, wherein the controller rotates the cam into the second cam position in response to detecting a current above a threshold level.

20. The method of claim 13, wherein there is no high voltage current path between the high voltage input terminal and the high voltage output terminal in the open position.
